(19) United States
(12) Patent Application Publication
(10) Pub. No.: US 2016/0200025 A1
(43) Pub. Date: Jul. 14, 2016

(54) THERMALLY INSULATED MELT PROCESSOR AND PROCESS FOR MELT PROCESSING WITH SAME

(71) Applicant: SABIC GLOBAL TECHNOLOGIES B.V., Bergen op Zoom (NL)

(72) Inventors: Kevin Scott Wassmer, Poseyville, IN (US); Franklin Ehrensbeck, Evansville, IN (US); Thad William Allen, Evansville, IN (US); Stephen Michael Wallace, Mount Vernon, IN (US); Thomas Usher Abell, Evansville, IN (US); Gerald Hagedorn, Henderson, KY (US)

(21) Appl. No.: 14/914,356

(22) PCT Filed: Aug. 29, 2014
(86) PCT No.: PCT/US2014/053348

§ 371 Date: Feb. 25, 2016

Related U.S. Application Data
(60) Provisional application No. 61/871,685, filed on Aug. 29, 2013.

(51) Int. Cl. B29C 47/82; H05B 3/62; H05B 1/02; B29B 13/02; B29C 47/80

(52) U.S. Cl. CPC B29C 47/822; B29B 13/022; B29C 47/802; H05B 1/023; H05B 3/62; B29K 2023/00

(57) ABSTRACT

A thermally insulated melt processor comprises a barrel (10) and a heater (40) disposed on the barrel. The heater comprises an insulating material (42) in contact with a surface of the barrel and a heat member (44) disposed in the insulating material and configured to provide heat in response conduction of electric current through the heat member.

### BACKGROUND

Extrusion of polymer materials under heat requires significant power due to inefficient thermal transfer into an extruder. The inefficiency is partly due to inefficient thermal contact between external metallic heaters and the extruder. Moreover, heat is radiated into an area surrounding the extruder instead of being transmitted into the body of the extruder, creating a thermal loss to the surrounding area which increases the temperature of the area. This area therefore requires increased power expenditures due to active cooling of the area such as by forced air or cooled air convection around the extruder. Further, exposed heaters operating at a temperature sufficient to drive the thermal load of the extruder and its polymeric contents are typically at a temperature in excess of the skin tissue damage threshold, which is around 52° C. To avoid direct skin contact with such heaters, a metallic cover is placed over the extruder and heater. The metallic cover is spaced apart from the heater; however, the metallic cover is heated by infrared radiation emitted from the heater such that the cover also attains a quite high temperature during extrusion.

Additionally, since the heater has inhomogeneous thermal contact with the extruder, a thermal hot spot occurs, and certain components of the extruder are subject to thermal damage. Moreover, the extruded polymer product may suffer from unwanted chemical or physical property variation due to the hot spot.

Improved heating and materials for controlling an extrusion process are always welcomed in the art.

### BRIEF DESCRIPTION

The above described and other features are exemplified by the following figures and detailed description.

Disclosed is a thermally insulated melt processor comprising: a barrel; and a heater disposed on the barrel and comprising: an insulating material in contact with a surface of the barrel; and a heat member disposed in the insulating material and configured to provide heat in response conduction of electric current through the heat member.

Additionally disclosed is a system for melt processing a polymer, the system comprising: the thermally insulated melt processor; and a controller electrically connected to the heat member.

Further disclosed is a process for reducing power consumption during melt processing a polymer, the process comprising: disposing a polymer in the thermally insulated melt processor, wherein the thermally insulated melt processor further comprises a screw member disposed in the barrel; passing an electrical current through the heat member to heat the barrel; applying a force to the polymer by rotating the screw member; and melting the polymer, wherein an efficiency of heating the barrel from the electrical current passed through the heat member is greater than or equal to 70%, based on the amount of electrical current through the heat member required to reach a temperature effective to melt the polymer.

### BRIEF DESCRIPTION OF THE DRAWINGS

Referring now to the figures, wherein like elements are numbered alike:

FIG. 1 is a photograph of a barrel of a melt processor;

FIG. 2 shows a side view of a barrel of a melt processor;

FIG. 3 shows a cross-section of a thermally insulated melt processor;

FIG. 4 shows a transverse cross-section of a heater;

FIG. 5 shows a longitudinal cross-section of the heater shown in FIG. 3;

FIG. 6 shows a transverse cross-section of a heater;

FIGS. 7 and 8 show a perspective view of a heater for a melt processor;

FIG. 9 shows a perspective view of heaters and a flange cover;

FIGS. 10 and 11 show a perspective of flange covers;

FIG. 12 is block diagram of a system for melt processing;

FIG. 13 is a photograph of a thermally insulated melt processor;

FIG. 14 is an enlarged view of a portion of the photograph of the thermally insulated melt processor shown in FIG. 13;

FIG. 15 is a photograph of a melt filter portion of a thermally insulated melt processor; and

FIG. 16 is a photograph of metallic heater disposed on a barrel of a melt processor.

### DETAILED DESCRIPTION

A detailed description is presented herein by way of exemplification and not limitation.

It has been found that a thermally insulated melt processor has beneficial properties. A heater that establishes an appreciable temperature differential between an underlying barrel of a melt processor and an exterior of the surface, resulting in reduced cooling requirements and overall operating expenses for melt processing polymers. Additionally, hot spots are absent, with uniform temperatures being produced along the barrel. Moreover, power consumption is greatly reduced compared to a metallic heater. Furthermore, the heater herein is flexible, lightweight, and easily configurable to various barrel shapes.

According to an example, a thermally insulated melt processor can include a barrel and a heater disposed on the barrel. The heater can include an insulating material in contact with a surface of the barrel and a heat member disposed in the insulating material and configured to provide heat in response conduction of electric current through the heat member.

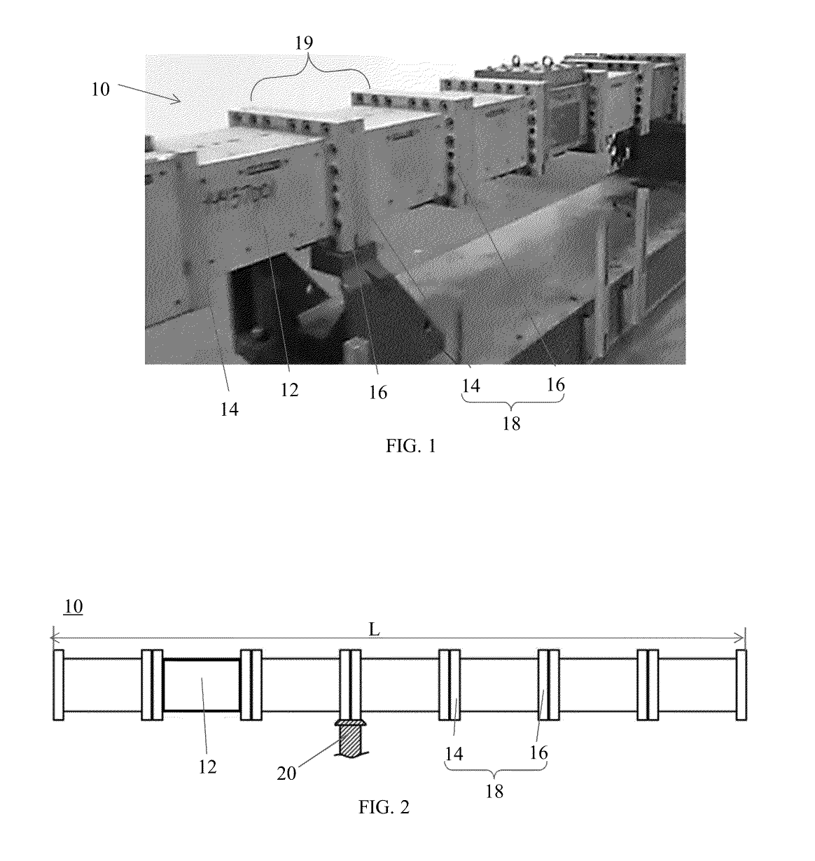

As shown in FIG. 1, a barrel 10 of a melt processor includes repeated nipple sections 19. Each nipple 19 has a tube 12 interposed between a first flange 14 and a second flange 16, which make up a pair of flanges 18. In some melt processors, instead of the repeated nipples 19, the barrel includes a single tube 12 with or without flanges (14, 16). The flanges 14, 16 can be attached to the tube 12, e.g., by a weld so that they are physically attached to the tube 12. The nipples 19 can be connected to one another so that flanges of adjacent nipples 19 contact. A fastener, e.g., a bolt and nut, can apply a force across abutting flanges of adjacent nipples 19 so that the barrel 10 can be a continuous body. A prop 20 can suspend the barrel 10 above a floor and adjust a vertical height of the barrel 10 to contact other equipment, such as a polymer feed source, melt filter, dye, and the like. For further illustration, a side view of a barrel 10 of a melt processor is shown in FIG. 2. Here, a length of the barrel is indicated as “L” in FIG. 2.

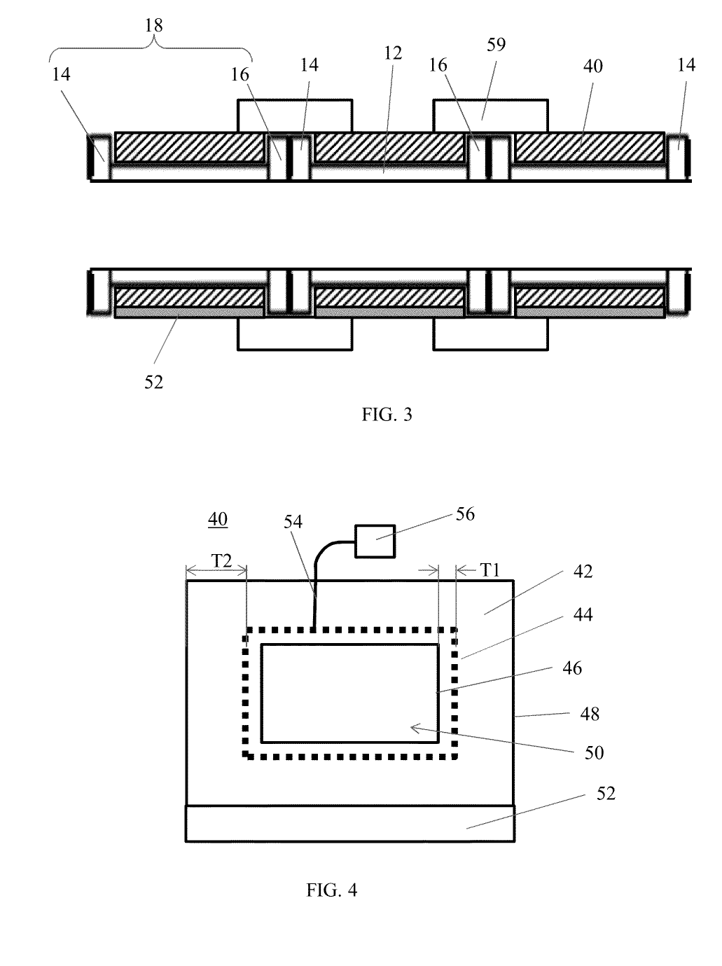

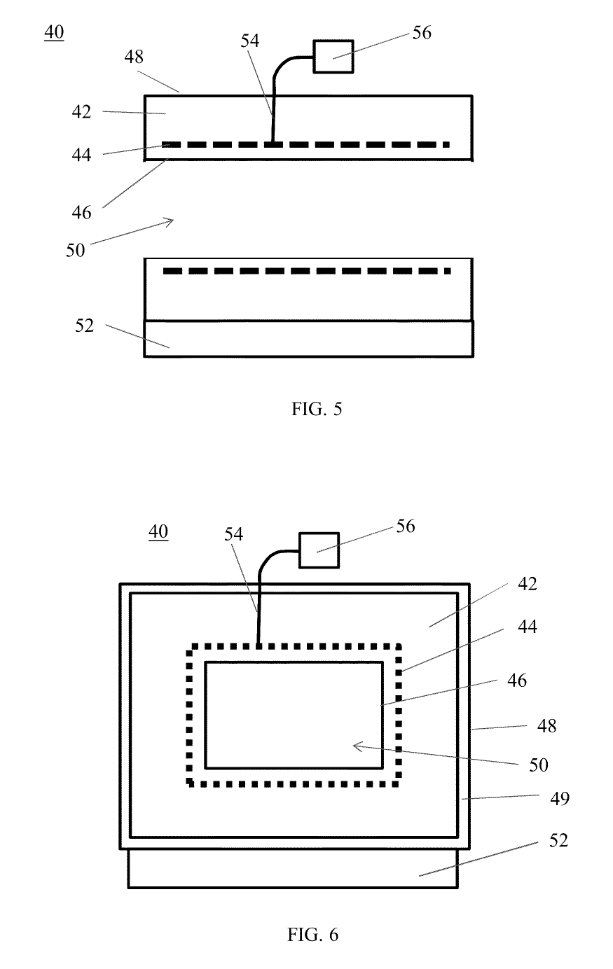

In an example, as shown in FIG. 3, a thermally insulated melt processor has a heater 40 disposed on a tube 12 between a pair of flanges 18. A flange cover can be disposed on an abutting flanges 14, 16 with a support 52 disposed on an exterior surface of the heater 40 to provide support of the heater 40 on the tube 12. FIGS. 4 and 5 show further details of the heater 40 in transverse and longitudinal cross-sections, respectively. In the heater 40, a heat member 44 is disposed in an insulating material 42. The heater 40 has an inner surface 46 surrounding a hollow space 50 through which the barrel of the melt processor is inserted. An exterior surface 48 is the outer boundary of the insulating material 42. The support 52 can be disposed on the exterior surface 48 of the insulating material 42 opposing the barrel 10. The support prevents a gap between the heater 40 and the barrel 10. An electrical lead 54 can be electrically connected to the heat member 44, and an electrical connector 56 can be arranged at a terminus of the electrical lead 54. The electrical connector 56 can connect to an external power cable to transmit electrical power to the heat member 44 via the electrical lead 54.

The heat member 44 can be disposed in the insulating material 42 such that the insulating material 42 has a first thickness T1 between the heat member 44 and the inner surface 46 of the heater. Likewise, a thickness T2 can be present between the heat member 44 and the exterior surface 48 of the heater 40. The thickness T1 can be greater than, less than, or equal to the thickness T2. In an example, the thickness T1 is less than the thickness T2. In this arrangement, the heat member 44 is relatively closer to the inner surface 46 and further away from the exterior surface 48 of the heater 40. As a result, during operation when the heat member 44 radiates heat, the inner surface 46 of the heater 44 can be hotter than the exterior surface 48. The ratio of the thickness T1 to thickness T2 can be, e.g., from 2:1 to 1:100, specifically from 1:1 to 1:10, and more specifically from 1:2 to 1:4.

In some exemplary heaters, the heater 40 includes an exterior layer 49 disposed on the insulating material 42 as shown in FIG. 6. The exterior layer 49 can be disposed on the entirety of the outer surface of the insulating material 42 such that the exterior surface 48 of the heater 44 is completely the exterior layer 49. Alternatively, only a portion of the outer surface of the insulating material 42 can be covered with the exterior layer 49 such that the exterior surface 48 includes a portion that is the exterior layer 49 and a portion that is the insulating material 42.

The shape of the barrel of the melt processor is useful for determining the shape of inner surface of the heater. Beneficially, the heater herein is flexible and conforms to the shape of the barrel. Therefore, regardless of the shape of the barrel, the heater thermal can contact the tube of the barrel with an absence of a gap between the inner surface of the heater and the tube. Although the barrel of the melt processor is shown as rectangular, exemplary cross-sectional shapes of the barrel can include round, elliptical, square, rectangular, polygonal, and the like. According to an example, the shape of the heater can be selected to correspond to the shape of the barrel to optimize the thermal contact between the heater and the barrel.

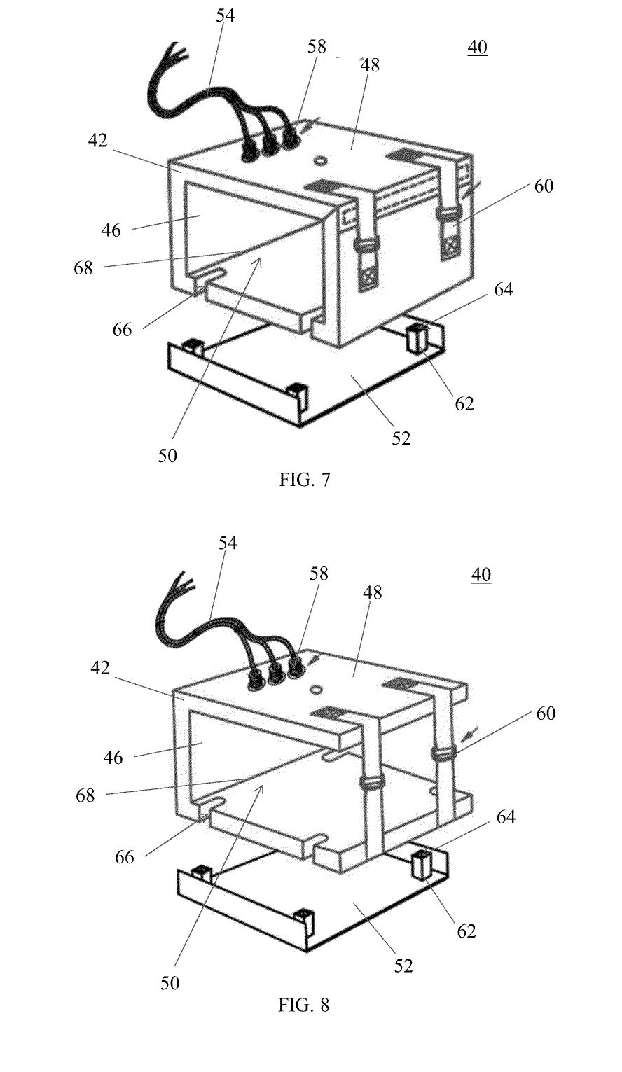

FIGS. 7 and 8 show examples of the heater. Here, in addition to the aforementioned features, the heater can include, e.g., a grommet 58 in which the electrical lead 54 is disposed to relieve bending stress on the electrical lead 54. Also, the grommet 58 can mechanically stabilize the electrical lead 54 relative to the exterior surface 48 of the heater 40 so that the electrical lead 54 is not easily removed from heater 40 or electrically disconnected from heat member (not shown) inside the heater 40 if the electrical lead 54 is subjected to a pulling force such as or being yanked or pulled. The heater 40 shown in FIG. 7 has rectangular cross-section with four sides. A fastener 60 can be disposed on the exterior surface 48 in order to snuggly fit the heater 40 over the barrel. It is contemplated that abutting walls of the heater 40 can meet and adjoin at a corner 68. In some configurations, the walls are a continuous piece so that there is no discontinuity along the inner surface 46 or the exterior surface 48. In an exemplary heater, a wall can be discontinuous with another wall so that the corner 68 is made by contacting the two walls together. According to an embodiment, as shown in FIG. 8, a portion such as a wall of the heater 40 is absent so that the heater has an open structure as opposed to the enclosed structure shown in FIG. 7.

With regard to the fastener 60, the fastener 60 can be, e.g., a belt, a band, and the like, that supplies a compressive force to the heater in order to join the walls of the heater 40, maintain the position of the heater 40 on a barrel, prevent a gap between the inner surface 46 of the heater 40 and the barrel, increase thermal contact between the heater 40 and the barrel, and the like. The fastener 60 can be disposed completely or partially (as in FIGS. 7 and 8) on a perimeter of the heater 40. In some exemplary heaters, the heater 40 does not include the fastener 60. The fastener 60 includes, e.g., a buckle to cinch and tighten the fastener 60 on the heater. Exemplary fasteners 60 include straps with a D-ring or other buckle or clasp, hook and lacing material, flaps, eyelets, fabric ties, and the like. Such fasteners 60 retain the heater 40 in position on the barrel without coming undone but are easily manipulated to be undone by, e.g., an operator. In this manner, the heater 40 can be easily and quickly removable from the barrel.

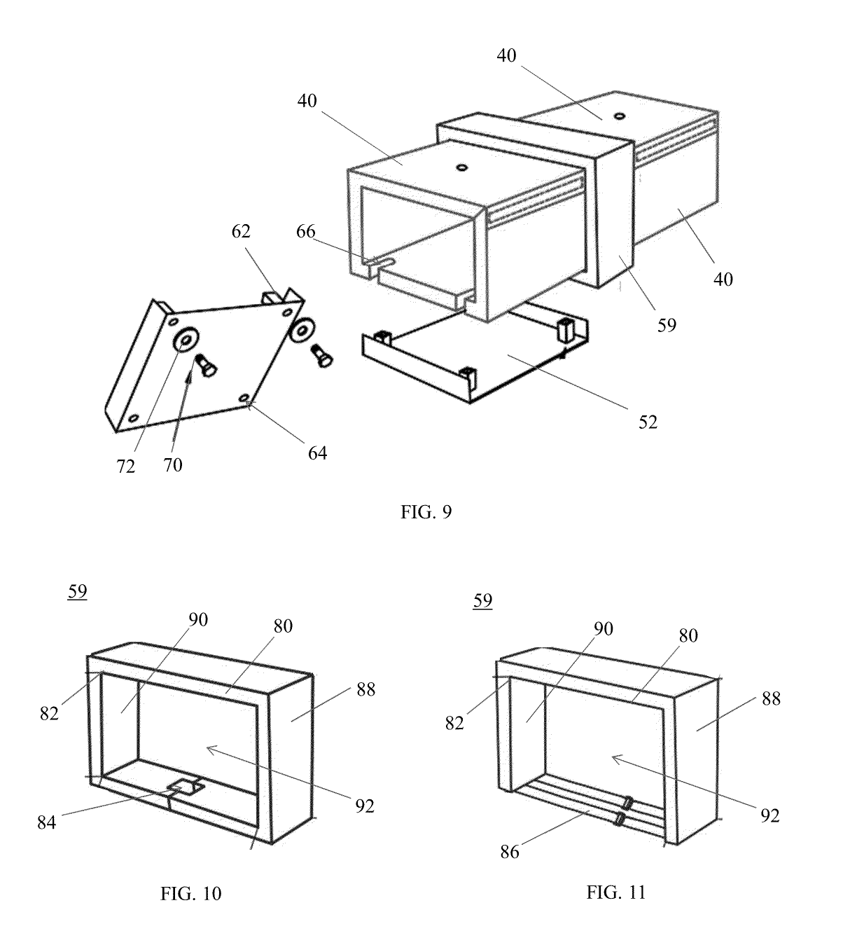

To aid in the structural integrity and to avoid formation of a gap between the heater 40 and barrel of the melt processor, the support 52 can be disposed on the heater. As shown in FIGS. 7, 8, and 9, the support 52 can be disposed on a side of the exterior surface 48 and includes an attachment guide 62 that has an attachment hole 64 for insertion of, e.g., a fastener 70 such as a bolt or a screw that engages with an optional washer 72, per FIG. 9. The attachment hole 64 can be a through hole that is tapped or not tapped. The attachment guide 62 is coupled into a keyway 66 located in the heater 40. The keyway 66 captures the attachment guide 62 so that support 52 does not inadvertently slip off of the heater 40. Alternatively, the keyway 66 is oversized with respect to the size of the attachment guide 62 such that support 52 easily detaches from the heater 40. Thus, the support 52 can be detachable from the heater 40 or can be permanently attached to the heater. In some melt processors, the barrel of the melt processor includes an attachment coupling that accepts the fastener 70 from the support 52 to attach the support fixedly to the barrel. The attachment coupling is, e.g., a tapped hole, a collet, hole into which the fastener 70 is press fit, and the like. The attachment coupling on the barrel may not penetrate into the core of the barrel where melt processing occurs.

The support 52 can be integrally disposed in the insulating material 42 of the heater 40 It is contemplated that here none or a portion of the support 52 is exposed to the external environment without being covered by the insulating material 42.

FIG. 9 also illustrates an assembly of two heaters 40 and a flange cover 59. The heaters 40 contact or do not contact each other inside the flange cover 59. The flange cover completely or partially surrounds the perimeter of the heater 40. Referring again to FIG. 3, it should be appreciated that flanges 14, 16 can separate adjacent heaters 40 within the flange cover 59. According to an example, more than one heater 40 is disposed on a single tube, and a flange cover optionally is disposed at on the junction where adjacent heaters 40 abut one another. In an example, the flange cover overlaps the heater. Here, the amount of overlap is selected, e.g., to optimize operating conditions of the melt processor, heating efficiency of the heater, accessing ease of the melt process or heater, or the like. In some configurations, the flange cover does not overlap the heater.

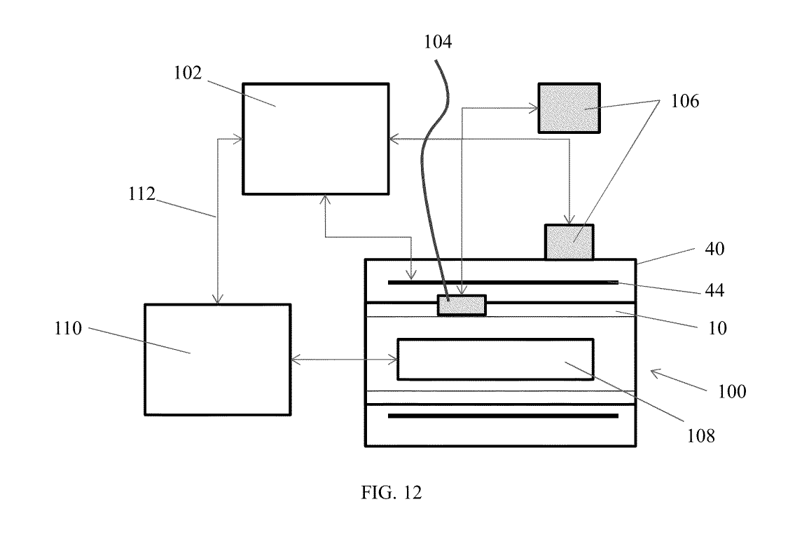

Embodiments of the flange cover 59 are shown in FIGS. 10 and 11. The flange cover includes insulating material 80, which is the same or different than the insulating material included in the heater. The flange cover 59 of FIG. 10 also includes a through hole 84 through which a tool (e.g., a diagnostic tool such as thermocouple, feeler gauge, pyrometer, wrench, and the like) is inserted. Such tool then interacts with the flange on which the flange cover is disposed. An optional corner is included in the flange cover 59 for certain flange cover shapes. The exterior surface 88 opposes the interior surface 90 that forms and surrounds a hollow core 92 in the flange cover 59. The flange cover 59 also can include a fastener 86. A portion of the flange cover 59 can be absent so that the flange cover has an open configuration as in FIG. 11 compared to the enclosed configuration shown in FIG. 10.

Additionally, the flange cover can include a secondary heat member disposed in the insulating material and is configured to heat the flange. In some circumstances, the secondary heat member is absent from the flange cover.

A sensor can be applied to the thermally insulated melt processor. Exemplary sensors include a temperature sensor, a pressure sensor, a moisture sensor, a fatigue sensor, an accelerometer, and the like. A temperature sensor can be disposed on the barrel to sense a temperature of the barrel.

The insulating material can be thermally insulating and can have a melting temperature or a thermal decomposition temperature greater than a temperature effective to perform melt processing of a polymer in the melt processor. According to an example, the insulating material has a melting temperature greater than or equal to 600° C., and more specifically greater than 500° C. The insulating material can be fibers (short or continuous) or strands. Exemplary insulating materials include glass, ceramic, high temperature polymers, and the like, such as silica, fiberglass, and the like. The insulating material can have less than or equal to 1,000 parts per million by weight (ppm), specifically, less than 500 ppm, of boron. The insulating material can have less than or equal to 10 ppm of various materials such as asbestos, lead, mercury, cadmium, and arsenic. The insulating material can be free of these materials (e.g., no measurable amount as determined with measurement standards as of the filing date of this application).

The insulating material can be fire retardant or fire suppressive. According to an example, the insulating material is electrically insulating. For a heater with an exterior layer, the exterior layer and the insulating material can be the same or different material. The exterior layer provides water or chemical resistance to the heater. The thickness of the insulating material is not limited particularly limited but is greater than 0.5 inch or thicker, e.g., from 1″ to 20″ thick, specifically from 1″ to 5″ thick.

With regard to the heat member, the heat member can be a bare wire or insulated with a high temperature coating. The heat member is a resistive element that provides heat to the heater and barrel through Joule heating. The heat member can be heated to greater than 700° C., specifically greater than 600° C., and more specifically greater than 350° C. It is contemplated that the wire is not susceptible to oxidation degradation during thermal cycling, cooling, heating, or temperature soaking. The heat member can be any number of forms, including ribbon, tape, wire, and the like with a cross-sectional shape that can be round, oval, square, rectangular, and the like. Such heat member can be straight or coiled. Resistive metals for construction of the heat member include Ni, Cr, Al, Fe Cu, an alloy thereof, and the like. Exemplary heat members are Nichrome, Kanthal, Cupronickel, and the like. Moreover, the heat member remains flexible even after attaining high temperatures and is readily bendable so that the heater conforms to the shape of the barrel. The heat member also connects to the electrical lead, which can be an electrically conductive metal although it may be the same or different resistive metal material as the heat member.

The heater also can include the support. The support can be made of metal, ceramic, polymer, or a combination comprising at least one of the foregoing. This material can have a high thermal degradation that is compatible with the temperature of the exterior surface of the heater. In an embodiment, the support is aluminum. The shape of the support is not limited and can be selected to achieve a high degree of thermal contact between the heater and the barrel of the melt processor.

The thermally insulated melt processor has a number of advantages and benefits. The heater can establish an appreciable temperature differential between the barrel and the exterior surface of the heater. The difference in a temperature at the surface of the barrel and a temperature at an exterior surface of the heater can be greater than or equal to 500° C., specifically greater than or equal to 400° C., and more specifically greater than or equal to 300° C. In an example, the exterior surface of the heater is less than 65° C., specifically less than 40° C. and more specifically less than 35° C., and the interior of the barrel is from 190° C. to 450° C. According to an example, the temperature of the exterior surface of the heater is less than or equal to 130° C. when the barrel has a temperature effective to melt process a polymer comprising a polyolefin, a polycarbonate, or a combination comprising at least one of the foregoing polymers. Due to the temperature differential across the heater, operating the thermally insulated melt processor herein has reduced cooling requirements and overall operating expenses for melt processing polymers.

Additionally, due to the high degree of thermal contact between flexible and conformable heater and the barrel, hot spots are absent or substantially absent so that a uniform temperature is produced along the barrel. Further, the quality of the product polymer is enhanced over other melt processing devices operating without the heater since the temperature of the barrel is more readily controlled by the heater. Since the heater contains the insulating material, the heater also insulates the barrel from heat losses. Heat can be generated inside the barrel, e.g., when a polymer is engaged by a screw member disposed in the barrel. However, this heat can be insulated from flowing to the surrounding environment due to the presence of the heater on the barrel of the melt processor. Thus, power consumption is greatly reduced compared to, e.g., a metallic heater.

The heater herein also can be lightweight, and easily configurable to various barrel shapes. In an example, the heater can have a weight less than or equal to 50, specifically 30 pounds, more specifically less than or equal 20 pounds, yet more specifically less than or equal to 10 pounds, and even more specifically less than or equal to 5 pounds.

The thermally insulated melt processor can have a barrel that includes a plurality of barrel sections, and each barrel section can have a tube interposed between a pair of flanges that are welded to the tube. A plurality of heaters can be disposed on the barrel such that a heater is disposed on the tube between the pair of flanges of each barrel section, and a flange cover can be disposed on the flanges of adjacent barrel sections. The heater can be configured to produce a temperature gradient along the length (e.g., along “L” as indicated in FIG. 2) of the thermally insulated melt processor. In some configurations, the heater can be configured to produce an isothermal temperature along a length of the thermally insulated melt processor. The barrel further can include a bore tube with a bore disposed in the bore tube and that extends along a length of the bore tube. A screw member can be disposed in the bore tube and configured to apply a force to a polymer disposed in the bore tube.

According to an example, the plurality of heaters can be controlled to reach the same or different temperature. They can be wired to be controlled independently or wired together in parallel or series. Therefore, a single temperature or zones of temperatures can be created along the length of the barrel.

A system for melt processing a polymer can include the thermally insulated melt processor 102 of FIG. 12 and a controller electrically connected to the heat member of the heater. That is, as show in FIG. 12, the system has controller 102 electrically connected to the heat member 44 inside the heater 40, which is disposed on the barrel 10. A temperature sensor 104 is disposed on the barrel 10. The system optionally includes a secondary 26. The controller can be electrically connected to a secondary temperature sensor 106, which is configured to sense a temperature of an external surface of the heater 40. The temperature sensor 104 and the secondary temperature sensor 106 independently can be a thermocouple, an RTD, a thermistor, an infrared camera, an infrared card, a pyrometer, and the like.

A screw member 108 disposed in the barrel 10 can be connected to a drive unit 110. The screw member 108 also can be configured to apply a force to a polymer that is subjected to melt processing in the barrel. The drive unit 110 can be configured to rotate the screw member 108. Electrical communication lines 112 can electrically connect the controller 102 to the temperature sensor 104, secondary temperature sensor 106, heat member 44, and drive unit 110. The drive unit 110 can be mechanically or electrically connected to the screw member 108. The communication lines 112 can be configured for one-way or two-way communication among the connected components.

According to an exemplary system, the controller 102 can be configured to supply current to the heat member 44. Here, the controller 102 can be configured to heat the heat member 44 to a selected temperature for melt processing the amount of power being based on the temperature of the barrel 10, which is derived from the temperature sensor 104. The controller also can provide commands to the drive unit 110 for driving the screw member.

In some systems, the screw member is a single screw. In a system, the screw member is twin screws, which co-rotate. A diameter of the screw can be from 10 mm to 300 mm.

The heater thermally insulates the melt processor and experiences very low heat losses from the heat member to the exterior surface of the heater while providing highly efficient heat transfer from the heat member to the barrel of the melt processor in part due to the large thermal contact between the heater and the barrel. Further, heat is not lost at the flanges to the environment since the flange cover is disposed on the flange. As such, the thermally insulated melt processor provided with the heater herein reduces energy consumption compared to an arrangement without using the heater herein.

Thus, a process for reducing power consumption during melt processing a polymer can include disposing a polymer in the thermally insulated melt processor that has a screw member disposed in the barrel. The process also can include passing an electrical current through the heat member to heat the barrel, applying a force to the polymer by rotating the screw member, and melting the polymer. An efficiency of heating the barrel from the electrical current passed through the heat member can be greater than or equal to 85%, specifically greater than or equal to 75%, and more specifically greater than or equal to 65%, based on the amount of electrical current through the heat member required to reach a temperature effective to melt the polymer. In an example, a temperature of an exterior surface of the heater can be less than or equal to 130° C. when the barrel has a temperature effective to melt the polymer, e.g., a polyolefin, a polycarbonate, or a combination comprising at least one of the foregoing polymers.

The thermally insulated melt processor can include other components. In some configurations, the process can include passing the polymer through a melt filter, a die, and other extruder components disposed in a chamber connected to the barrel.

Set forth below are some embodiments of the apparatus, system, and process.

Embodiment 1: A thermally insulated melt processor comprising: a barrel; and a heater disposed on the barrel, wherein the heater comprises: an insulating material in contact with a surface of the barrel; and a heat member disposed in the insulating material and configured to provide heat in response conduction of electric current through the heat member.

Embodiment 2: The thermally insulated melt processor of Embodiment 1, wherein the heater further comprises a support disposed on a surface of the insulating material opposing the barrel, the support preventing a gap between the heater and the barrel.

Embodiment 3; The thermally insulated melt processor of Embodiment 2, wherein the support is detachable from the heater.

Embodiment 4: The thermally insulated melt processor of any of Embodiments 2-3, wherein the support comprises a metal, ceramic, polymer, or a combination comprising at least one of the foregoing.

Embodiment 5: The thermally insulated melt processor of any of the previous Embodiments, wherein the insulating material has a thickness and is rectangular in shape having a height, width, and length, wherein the height is 1.5 to 5.0 times the width, the length is 2.0 to 10.0 times the height, and the thickness is from 1 to 10 cm.

Embodiment 6: The thermally insulated melt processor of any of the previous Embodiments, wherein the barrel comprises barrel sections, and wherein the insulating material around each barrel section comprises a single piece of insulation surrounding joined with itself at only one point (e.g., forming a single seam).

Embodiment 7: A thermally insulated melt processor of any of the previous Embodiments, wherein the insulating material comprises ceramic fiber that is free of asbestos.

Embodiment 8: A thermally insulated melt processor of any of the previous Embodiments, wherein the insulating material comprises ceramic fiber that is free of each of lead, mercury, cadmium, and arsenic.

Embodiment 9: A thermally insulated melt processor of any of the previous Embodiments, wherein the insulating material comprises ceramic fiber that has less than 1,000 ppm boron.

Embodiment 10: A thermally insulated melt processor of any of the previous Embodiments, wherein the heat member comprises a wire heating element wherein the wire heating element has a diameter of 0.5 to 4.0 mm, and when installed on the barrel, the wire heating element is less than or equal to 10 mm from a surface of the barrel.

Embodiment 11: A thermally insulated melt processor of any of the previous Embodiments, wherein the heat member comprises a wire heating element wherein the wire heating element is shaped into a flat coil, wherein the flat coil is a sinusoidal wave shaped, and wherein the amplitude of sinusoidal wave is at least 10 times a diameter of the wire heating element.

Embodiment 12: A thermally insulated melt processor of any of the previous Embodiments, wherein the heat member comprises a wire heating element, and wherein the wire heating element is an alloy, and wherein the alloy comprising at least two of nickel, chromium, iron, copper, molybdenum, tungsten, and manganese, (e.g., preferably comprises nickel and chromium).

Embodiment 13: A thermally insulated melt processor of any of the previous Embodiments, wherein the heater draws less than or equal to 6000 watts of power (e.g., between 0 and 6000 W, and specifically, between 100 and 4000 W).

Embodiment 14: A thermally insulated melt processor of any of the previous Embodiments, wherein the heater further comprises an outer layer forming a water barrier, wherein the outer layer comprises a metal, a silicone, a thermoset resin, or a combination comprising at least one of the foregoing.

Embodiment 15: The thermally insulated melt processor of any of the previous Embodiments, wherein the heater is in direct contact with the barrel such that a gap is absent between the heater and the barrel.

Embodiment 16: The thermally insulated melt processor of any of the previous Embodiments, wherein the barrel comprises a flange disposed at a terminus of a tube.

Embodiment 17: The thermally insulated melt processor of Embodiment 16, wherein the heater is disposed on the tube, and a flange cover is disposed on the flange, and further comprising a flange cover comprising a flange insulating material that is the same or different than the insulating material of the heater.

Embodiment 18: The thermally insulated melt processor of Embodiment 17, wherein the flange cover further comprises a secondary heat member disposed in the insulating material and is configured to heat the flange.

Embodiment 19: The thermally insulated melt processor of any of the previous Embodiments, wherein the barrel comprises:

a plurality of a barrel sections, each barrel section comprising:
a tube; and
a pair of flanges separated by the tube and attached at an opposing terminus of the tube,

wherein the barrel sections are arranged such that the flanges of adjacent barrel sections are in contact with one another, and

a plurality of the heaters are disposed on the barrel such that a heater is disposed on the tube between the pair of flanges of each barrel section, and a flange cover is disposed on the flanges of adjacent barrel sections.

Embodiment 20: The thermally insulated melt processor of any of Embodiments 1-18, wherein the barrel comprises: a tube; a bore disposed in the tube and which extends along a length of the tube; and a screw member disposed in the bore and configured to apply a force to a polymer.

Embodiment 21: The thermally insulated melt processor of any of the previous Embodiments, further comprising a temperature sensor disposed on the barrel to sense a temperature of the barrel.

Embodiment 22: The thermally insulated melt processor of any of the previous Embodiments, wherein the heater further comprises an electrical connector to electrically connect the heat member to a power source.

Embodiment 23: The thermally insulated melt processor of any of the previous Embodiments, wherein the heater is flexible and conforms to a shape of the barrel.

Embodiment 24: The thermally insulated melt processor of any of the previous Embodiments, wherein the heater is detachable from the barrel.

Embodiment 25: The thermally insulated melt processor of any of the previous Embodiments, wherein the heater is configured to produce a temperature gradient along a length of the thermally insulated melt processor.

Embodiment 26: The thermally insulated melt processor of any of the previous Embodiments, wherein the heater is configured to produce an isothermal temperature along a length of the thermally insulated melt processor.

Embodiment 27: The thermally insulated melt processor of any of the previous Embodiments, wherein a difference in a temperature at the surface of the barrel and a temperature at an exterior surface of the heater is greater than or equal to 300° C.

Embodiment 28: The thermally insulated melt processor of any of the previous Embodiments, wherein a temperature of an exterior surface of the heater is less than or equal to 130° C. when the barrel has a temperature effective to melt process a polymer comprising a polyolefin, a polycarbonate, or a combination comprising at least one of the foregoing polymers.

Embodiment 29: The thermally insulated melt processor of any of the previous Embodiments, wherein the insulating material is electrically insulating.

Embodiment 30: The thermally insulated melt processor of any of the previous Embodiments, wherein the heater has a weight less than or equal to 20 pounds.

Embodiment 31: A thermally insulated melt processor of any of the previous Embodiments, wherein the melt processor is single screw extruder with a 1.0 to 8.0 inch diameter screw operating at 100 to 500 rpm.

Embodiment 32: A thermally insulated melt processor of any of Embodiments 1-29, wherein the melt processor is a co-rotating twin screw extruder with 1.0 to 8.0 inch diameter screws operating at 200 to 1000 rpm.

Embodiment 33: A system for melt processing a polymer, the system comprising:

the thermally insulated melt processor of any of the previous Embodiments; and a controller electrically connected to the heat member.

Embodiment 34: The system of Embodiment 33, wherein the controller is configured to supply current to the heat member.

Embodiment 35: The system of any of Embodiments 33-34, wherein the controller is electrically connected to a temperature sensor disposed on the barrel.

Embodiment 36: The system of any of Embodiments 33-35, wherein the controller is configured to heat the heat member to a selected temperature, based on the temperature of the barrel.

Embodiment 37: The system of any of Embodiments 33-36, wherein the controller is electrically connected to a secondary temperature sensor, the secondary temperature sensor is configured to sense a temperature of an external surface of the heater.

Embodiment 38: The system of any of Embodiments 33-37, wherein the thermally insulated melt processor further comprises: a screw member disposed in the barrel, the screw member configured to apply a force to a polymer which is subjected to melt processing in the barrel; and a drive unit connected to the screw member and configured to rotate the screw member; and wherein the controller is electrically connected to the drive unit and is configured to control the drive unit.

Embodiment 39: A process for reducing power consumption during melt processing a polymer, the process comprising:

processing a polymer in the thermally insulated melt processor of any of Embodiments 1-32, wherein the thermally insulated melt processor further comprises a screw member disposed in the barrel;

passing an electrical current through the heat member to heat the barrel;

applying a force to the polymer by rotating the screw member; and

melting the polymer; and

wherein an efficiency of heating the barrel from the electrical current passed through the heat member is greater than or equal to 70%, based on the amount of electrical current through the heat member required to reach a temperature effective to melt the polymer.

Embodiment 40: The process of Embodiment 39, further comprising passing the polymer through a die disposed in a container connected to the barrel.

Embodiment 41: The process of any of Embodiments 39-40, wherein a temperature of an exterior surface of the heater is less than or equal to 130° C. when the barrel has a temperature effective to melt the polymer.

Embodiment 42: The process of any of Embodiments 39-41, wherein the polymer comprises a polyolefin, a polycarbonate, or a combination comprising at least one of the foregoing polymers.

The embodiments are further illustrated by the following non-limiting examples.

### EXAMPLE 1

### Thermally Insulated Melt Processor

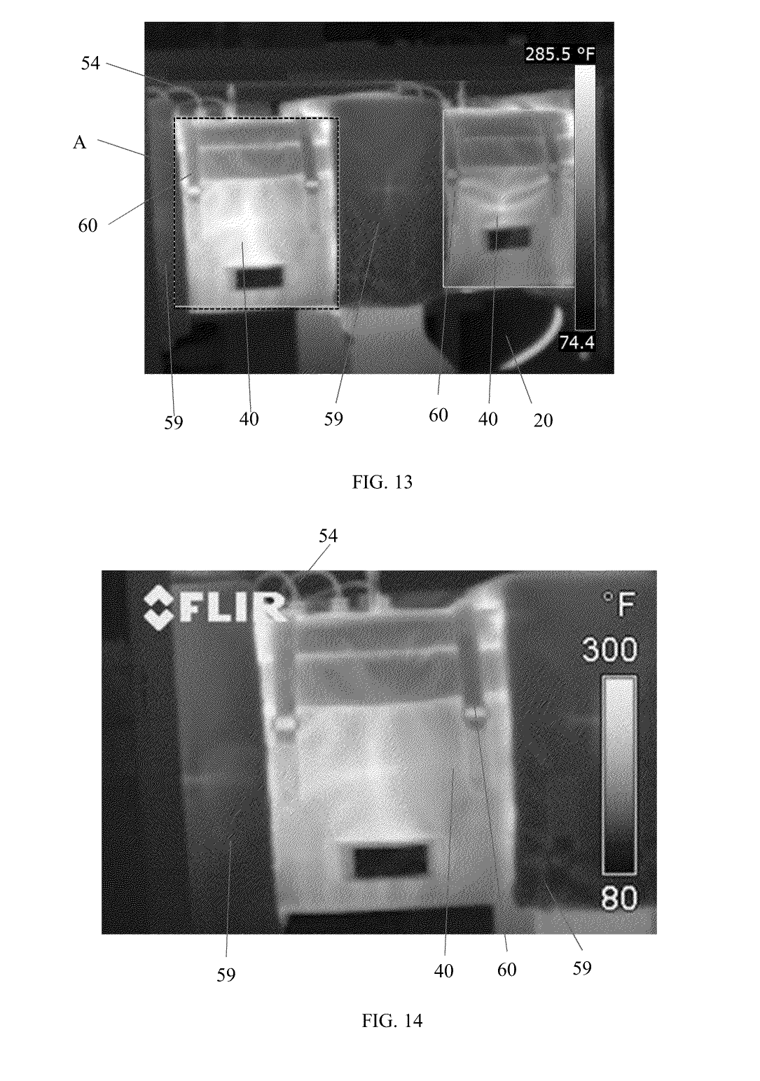

A melt processor was outfitted with a heater as described above. The melt processor had a barrel with a 273.0 mm×412.8 mm rectangular cross-section and was 3570 mm in length. A 133 mm twin screw mechanism was inside the barrel. The heater was heated so that the barrel attained a temperature of 287.8° C. and was held at that temperature for >24 hours. A polycarbonate polymer was introduced into the barrel, and the twin screw was rotated to melt and move the polymer down a length of the barrel. As show in FIG. 13, although the temperature of the barrel was 287.8° C., the exterior surface of the heater was about 120° C. This exterior temperature was lowered to 55° C. with removal of a shroud (not shown in FIG. 13) that previously surrounded the heater immediately before acquiring the photograph shown in FIG. 13. An enlarged view of the area marked by “A” in FIG. 13 is shown in FIG. 14.

### EXAMPLE 2

### Thermally Insulated Melt Filter Assembly

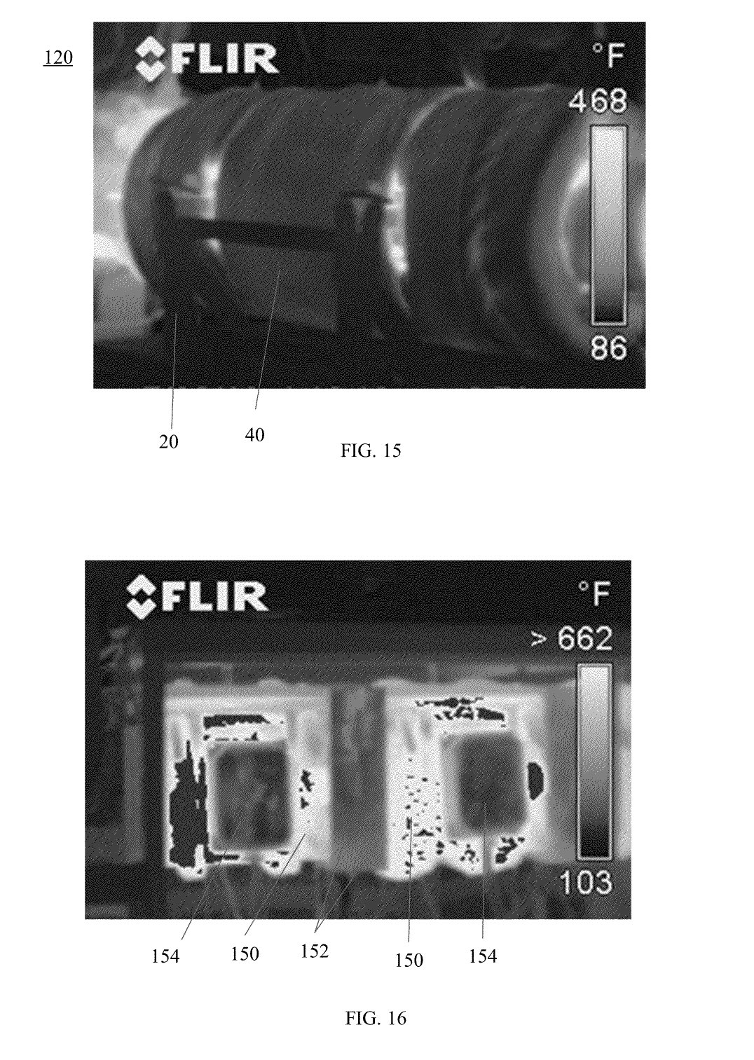

A melt filter assembly was outfitted with a heater as described above. The melt filter chamber had a round cross-section with a diameter from 381 mm to 762 mm and length of 406 mm to 1016 mm The melt filter inside the assembly included a series of disks or candle filtration elements. The heater was heated so that the chamber attained a temperature of 310° C. and was held at that temperature for >24 hours. The melt processed polymer from Example 1 was introduced into the assembly filtered. As show in FIG. 15, although the temperature of the chamber was 390° C., the exterior surface of the heater was about 46° C.

### COMPARATIVE EXAMPLE

### Metal Band Heater

A melt processor was outfitted with a metal band heater that wrapped around the barrel of the melt processor. The melt processor had a barrel with a 273.0 mm×412.8 mm rectangular cross-section and was 3570 mm in length. A 133 mm twin screw mechanism was inside the barrel. The metal band heater was heated so that the barrel attained a temperature of 287.8° C. and held at that temperature for >24 hours. A polycarbonate polymer was introduced into the barrel, and the twin screw was rotated to melt and move the polymer down a length of the barrel. As show in FIG. 17, the temperature of the exterior surface of the heater was >350° C. Thus, exterior temperature with a metallic band heater is much greater by a factor of about 6.4 times that of the heater in Example 1.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. A thermally insulated melt processor comprising:
a barrel; and
a heater disposed on the barrel, wherein the heater comprises:
an insulating material in contact with a surface of the barrel; and
a heat member disposed in the insulating material and configured to provide heat in response conduction of electric current through the heat member.

2. The thermally insulated melt processor of claim 1, wherein the heater further comprises a support disposed on a surface of the insulating material opposing the barrel, the support preventing a gap between the heater and the barrel; and wherein the support is detachable from the heater, and wherein the support comprises a metal, ceramic, polymer, or a combination comprising at least one of the foregoing.

3. (canceled)

4. The thermally insulated melt processor of claim 1, wherein the insulating material has a thickness and is rectangular in shape having a height, width, and length, wherein the height is 1.5 to 5.0 times the width, the length is 2.0 to 10.0 times the height, and the thickness is from 1 to 10 cm.

5. The thermally insulated melt processor of claim 1, wherein the barrel comprises barrel sections, and wherein the insulating material around each barrel section comprises a single piece of insulation surrounding joined with itself at only one point.

6. A thermally insulated melt processor of claim 1, wherein the insulating material comprises ceramic fiber that comprises less than 10 ppm of asbestos, less than 10 ppm lead, less than 10 ppm mercury, less than 10 ppm cadmium, and less than 10 ppm arsenic, and less than 1,000 ppm boron.

7. A thermally insulated melt processor of claim 1, wherein the heat member comprises a wire heating element wherein the wire heating element has a diameter of 0.5 to 4.0 mm, and when installed on the barrel, the wire heating element is less than or equal to 10 mm from a surface of the barrel.

8. A thermally insulated melt processor of claim 1, wherein the heat member comprises a wire heating element wherein the wire heating element is shaped into a flat coil, wherein the flat coil is a sinusoidal wave shaped, and wherein the amplitude of sinusoidal wave is at least 10 times a diameter of the wire heating element.

9. A thermally insulated melt processor of claim 1, wherein the heat member comprises a wire heating element, and wherein the wire heating element is an alloy, and wherein the alloy comprising at least two of nickel, chromium, iron, copper, molybdenum, tungsten, and manganese.

10. A thermally insulated melt processor of claim 1, wherein the heater draws less than or equal to 6000 watts of power.

11. A thermally insulated melt processor of claim 1, wherein the heater further comprises an outer layer forming a water barrier, wherein the outer layer comprises a metal, a silicone, a thermoset resin, or a combination comprising at least one of the foregoing.

12. The thermally insulated melt processor of claim 1, wherein the heater is in direct contact with the barrel such that a gap is absent between the heater and the barrel.

13. The thermally insulated melt processor of claim 1, wherein the barrel comprises a flange disposed at a terminus of a tube, wherein the heater is disposed on the tube, and a flange cover is disposed on the flange, and further comprising a flange cover comprising a flange insulating material that is the same or different than the insulating material of the heater, and wherein the flange cover further comprises a secondary heat member disposed in the insulating material and is configured to heat the flange.

14. The thermally insulated melt processor of claim 1, wherein the barrel comprises:
a plurality of a barrel sections, each barrel section comprising:
a tube; and
a pair of flanges separated by the tube and attached at an opposing terminus of the tube,
wherein the barrel sections are arranged such that the flanges of adjacent barrel sections are in contact with one another, and
a plurality of the heaters are disposed on the barrel such that a heater is disposed on the tube between the pair of flanges of each barrel section, and a flange cover is disposed on the flanges of adjacent barrel sections.

15. The thermally insulated melt processor of claim 1, wherein the barrel comprises:
a tube;
a bore disposed in the tube and which extends along a length of the tube; and
a screw member disposed in the bore and configured to apply a force to a polymer.

16. The thermally insulated melt processor of claim 1, wherein the heater is flexible and conforms to a shape of the barrel, wherein the heater is detachable from the barrel, and wherein the heater is configured to produce a temperature gradient along a length of the thermally insulated melt processor.

17. The thermally insulated melt processor of claim 1, wherein the heater is configured to produce an isothermal temperature along a length of the thermally insulated melt processor.

18. The thermally insulated melt processor of claim 1, wherein a difference in a temperature at the surface of the barrel and a temperature at an exterior surface of the heater is greater than or equal to 300° C., and wherein a temperature of an exterior surface of the heater is less than or equal to 130° C. when the barrel has a temperature effective to melt process a polymer comprising a polyolefin, a polycarbonate, or a combination comprising at least one of the foregoing polymers.

19. (canceled)

20. A thermally insulated melt processor of claim 1, wherein the melt processor is single screw extruder with a 1.0 to 8.0 inch diameter screw operating at 100 to 500 rpm, or wherein the melt processor is a co-rotating twin screw extruder with 1.0 to 8.0 inch diameter screws operating at 200 to 1000 rpm.

21. A system for melt processing a polymer, the system comprising:
the thermally insulated melt processor of claim 1; and
a controller electrically connected to the heat member;
wherein the controller is configured to supply current to the heat member, wherein the controller is electrically connected to a temperature sensor disposed on the barrel, and wherein the controller is configured to heat the heat member to a selected temperature, based on the temperature of the barrel, and wherein the controller is electrically connected to a secondary temperature sensor, the secondary temperature sensor is configured to sense a temperature of an external surface of the heater.

22. A process for reducing power consumption during melt processing a polymer, the process comprising:
processing a polymer in the thermally insulated melt processor of claim 1, wherein the thermally insulated melt processor further comprises a screw member disposed in the barrel;
passing an electrical current through the heat member to heat the barrel;
applying a force to the polymer by rotating the screw member; and
melting the polymer,
wherein an efficiency of heating the barrel from the electrical current passed through the heat member is greater than or equal to 70%, based on the amount of electrical current through the heat member required to reach a temperature effective to melt the polymer; and
wherein the polymer comprises a polyolefin, a polycarbonate, or a combination comprising at least one of the foregoing polymers.
